(19) United States
(12) Patent Application Publication
(10) Pub. No.: US 2005/0248821 A1
(43) Pub. Date: Nov. 10, 2005

(54) Method and device for producing individualized holograms

(76) Inventors: Steffen Noehte, Weinheim (DE); Christoph Dietrich, Heidelberg (DE); Robert Thomann, Heidelberg (DE); Matthias Gerspach, Heidelberg (DE); Jorn Leiber, Hamburg (DE); Stefan Stadler, Hamburg (DE)

Correspondence Address: PROSKAUER ROSE LLP;PATENT DEPARTMENT, 1585 BROADWAY, NEW YORK, NY, 10036-8299, US

(21) Appl. No.: 10/474,581

(22) PCT Filed: Mar. 28, 2002
(86) PCT No.: PCT/EP02/03497

§ 371 Date: Mar. 15, 2004

(30) Foreign Application Priority Data
Apr. 12, 2001 (EP) 101 18 590.1

(51) Int. Cl. G03H 1/00

(52) U.S. Cl. 359/30

(57) ABSTRACT

The present invention relates to methods of producing an individualized digital computer-generated hologram, in which the technical problem of being able to draw conclusions from the holograms about the associated writing device is achieved in that a hologram is written into a storage medium as a matrix of individual points, in that a geometric pattern for writing the holographic information in is predefined, and in that an individualizing feature is superimposed on the hologram by writing in a large number of individual points deviating from the predefined pattern. The invention also relates to a reading method and a storage medium having an individualized hologram.

The present invention relates to the use of digital holograms as an individual feature and thus to a method and an apparatus (writing device) for producing the individual digital holograms.

Digital holograms are two-dimensional holograms which consist of individual points with different optical properties and from which, when illuminated with a coherent electromagnetic wave, in particular a light wave, images and/or data are reproduced by means of diffraction in transmission or reflection. The different optical properties of the individual points can be reflective material properties, for example as a result of surface topography, varying optical path lengths in the material of the storage medium (refractive index) or color values.

The optical properties of the individual points are calculated by a computer, and it is thus what is known as a computer-generated hologram (CGH). With the aid of the focused write beam, during the writing of the hologram the individual points of the hologram are written in into the material, the focus being located in the region of the surface or in the material of the storage medium. In the region of the focus, focusing has the effect of a small area of action on the material of the storage medium, so that a large number of points of the hologram can be written on a small area. The optical property of the respectively written point in this case depends on the intensity of the write beam. For this purpose, the write beam is scanned in two dimensions over the surface of the storage medium with varying intensity. The modulation of the intensity of the write beam is in this case carried out either via internal modulation of the light source, for example a laser diode, or via external modulation of a write beam outside the light source, for example with the aid of optoelectronic elements. Furthermore, the light source can be formed as a pulsed laser whose pulse lengths can be controlled, so that control of the intensity of the write beam can be carried out by the pulse lengths.

As a result of the scanning of the intensity-modulated write beam, an area with an irregular point distribution is thus produced, the digital hologram. This can be used to identify and individualize any desired objects.

Scanning lithographic systems are intrinsically widespread. For example, scanning optical systems are incorporated in conventional laser printers. However, these systems cannot be used for the production of holograms, since the requirements for this intended application differ considerably from those in laser printers. In the case of good printing systems, the resolution is around 2500 dpi while, in the production of holograms, a resolution of about 25 000 dpi is required. In addition, in digital holography, only comparatively small areas are written. These are, for example, 1 to 5 mm², other sizes also being possible. The accuracy of the write pattern in the case of a lithograph for the production of digital holograms of, for example, 1000×1000 points on an area of 1×1 mm² must be about ±0.1 μm in both orthogonal directions. Furthermore, the writing speed must be about 1 Mpixel/s, in order that in each case a hologram can be written in a time of about 1 s. The aforementioned magnitudes are exemplary and do not constitute any restriction of the invention.

Digital holograms can be produced by means of conventional scanning methods, with which the angle of the incident beam is varied by stationary optics. For example, scanning mirror lithographs with galvanometer and/or polygonal scanners operate on this principle.

One problem with the holograms described previously is that these are forged. There has therefore been for a long time the desire for it to be possible to draw conclusions from the written holograms about the lithograph which has written the hologram. Hitherto, however, there was no satisfactory solution to this.

The present invention is therefore based on the technical problem of specifying a method and an apparatus in which conclusions can be drawn from the holograms about the associated writing device.

The technical problem indicated previously is achieved according to the invention by a method as claimed in claim 1, in which points are written which deviate specifically from a predefined pattern of a digital computer-generated hologram to be written, from which points the at least one individualizing feature can be derived during the reproduction of the hologram.

The principle of the solution is based on the use of an apparatus for controlling the exposure operation. This apparatus permits the accurate positioning of the individual points to be written by the lithograph within a predefined pattern. This accurate control can, however, also be used to deviate from the predefined pattern, in order to write points of the digital computer-generated hologram specifically positioned differently from the pattern.

A suitable apparatus can have what is known as a trigger matrix in which a scanning beam, which is moved as a function of the write beam, scans a light-sensitive detector. When the scanning beam strikes one of the pixels of the trigger matrix, a trigger signal is generated, with which the write beam is controlled in order to write a point of the hologram at the position in the storage medium which coincides with the pixel struck in the trigger matrix. The scanning beam is either produced separately from the write beam and deflected by the same deflection devices (scanning mirror) as the write beam, or the scanning beam is separated off as part of the write beam and is thus automatically correlated in its movement with the write beam.

It is emphasized that, instead of such a trigger matrix, another type of beam guidance and time triggering can be used. It is simply a matter that the write beam can be positioned very accurately.

In exactly the same way in which it is possible to position the points to be exposed exactly in an orthogonal pattern, that is to say for example with an accuracy of 0.1 μm, it is also possible to deviate from this pattern in a predefined manner.

In this case, the deviations from the pattern can be made in a different manner, the different deviations having different consequences. There are deviations which can be perceived only microscopically, that is to say by inspecting the individual points by means of a microscope.

On the other hand, there are deviations which can even be detected macroscopically by holographic reading. Both possibilities can be used to establish the originality of the written hologram, that is to say in particular permit conclusions to be drawn about the writing device.

In other words, the principle of the solution can also be understood simply as an additional security feature which may be read microscopically and/or macroscopically holographically.

The technical problem indicated above is also solved by a method of reading an individualized digital computer-generated hologram, in which the hologram written in a storage medium is illuminated with a beam of electromagnetic radiation, the hologram having basic information and at least one individualizing feature, in which the image produced by the hologram is recorded by recording means and evaluated with the aid of image recognition, and in which the at least one individualizing feature obtained in the hologram is checked.

Likewise, the technical problem indicated above is solved by means of a storage medium having a digital computer-generated hologram which has individual points which are written into the material of the storage medium, are arranged in a predefined geometric pattern and form the hologram. Furthermore, a large number of individual points is provided, which are written in the material of the storage medium in a manner differing from the predefined pattern.

In the following text the invention will be explained in more detail using exemplary embodiments and with reference to the appended drawing, in which:

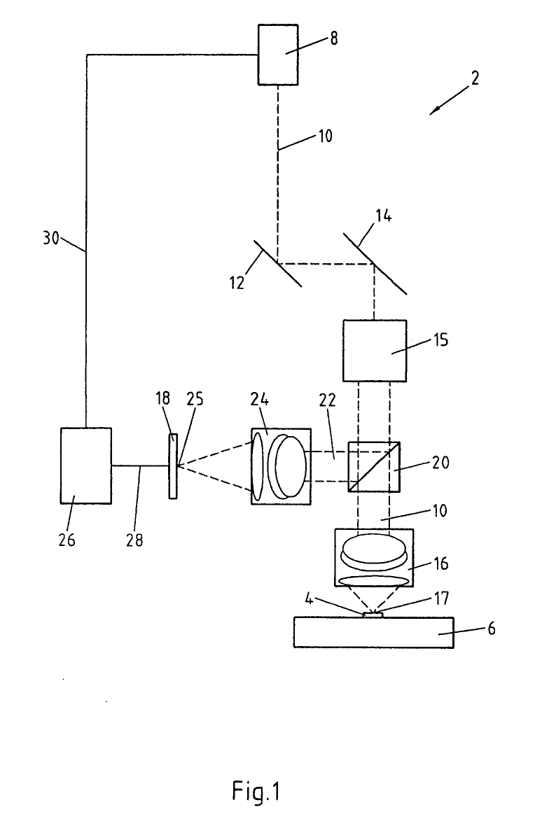

FIG. 1 shows an exemplary embodiment of a lithograph for producing holograms,

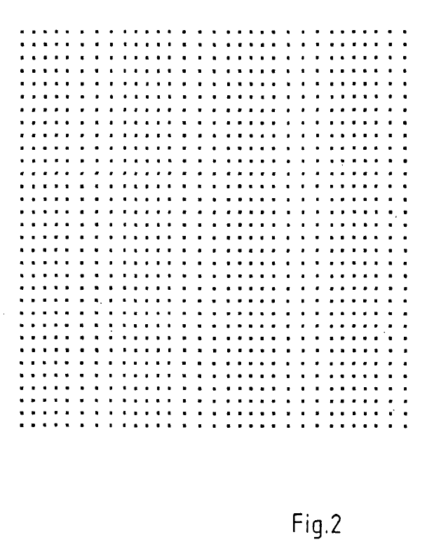

FIG. 2 shows a first point distribution of a digital hologram with deviations of the point distribution from the grid arrangement,

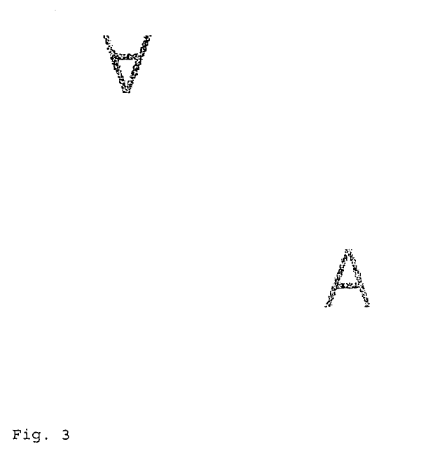

FIG. 3 shows the image reproduced from a hologram illustrated in FIG. 2 with what are known as ghost images,

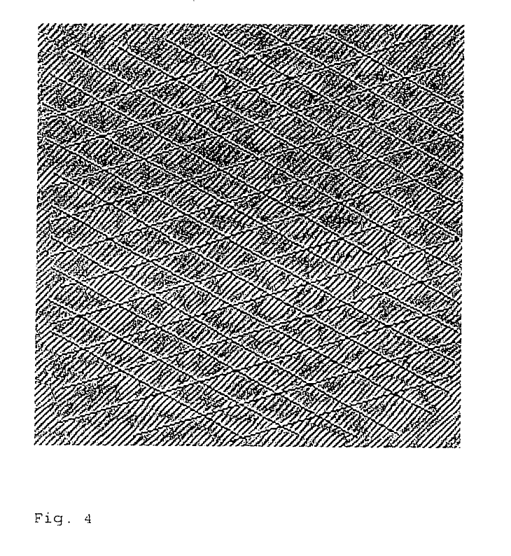

FIG. 4 shows a second point distribution of a digital hologram with deviations of the point distribution from the grid arrangement,

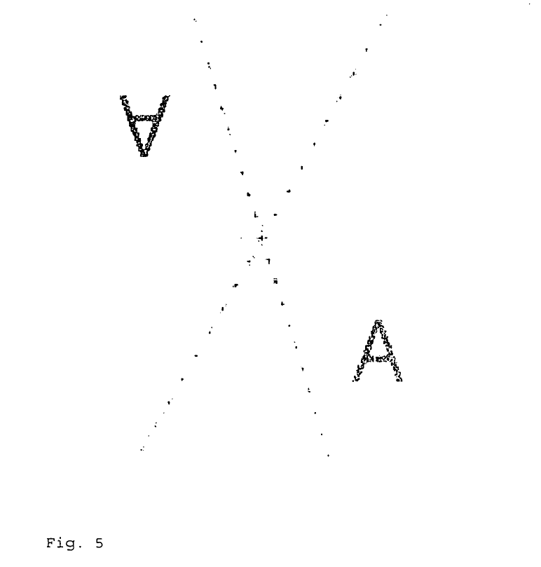

FIG. 5 shows an image reproduced from a hologram illustrated in FIG. 4 with what are known as ghost images.

FIG. 1 shows a lithograph 2 according to the invention for producing digital holograms in a storage medium 4 which is arranged on a carrier 6. A light source 8 for producing a write beam 10 preferably has a laser or a laser diode, so that the write beam 10 is formed as a laser beam.

The lithograph 2 also has drive means for the two-dimensional movement of the write beam 10 relative to the storage medium 4, which are formed as galvanometrically driven scanning mirrors 12 and 14 and deflect the writing beam in two x and y directions arranged substantially orthogonally to each other. The x direction runs, for example, in the plane of FIG. 1 and the y direction runs in a plane at right angles to the plane of the Figure. The mirrors 12 and 14 therefore constitute an x/y scanning mirror arrangement. Instead of one of the two or both galvanometric scanning mirrors, rotatable polygonal mirrors can also be used.

Optionally, a beam spreader or collimator 15 is also arranged in the beam path, behind the scanning mirrors 12 and 14, in order to produce a widened write beam 10.

A first objective 16 focuses the write beam 10 onto the storage medium 4 to be written, so that, at the focus 17, depending on the focused intensity of the write beam 10, the optical property of the storage medium 4 is changed or remains unchanged.

A two-dimensional trigger matrix 18 is provided, onto which a scanning beam 22 coupled out of the write beam 10 by a beam splitter 20 is focused at a focus 25 by a second objective 24.

The two objectives 16 and 24 in each case have three lenses of a focusing lens system. However, the precise configuration of the objectives 16 and 24 is unimportant. However, the objectives 16 and 24 ensure that their angular deflections in the x/y direction depend, preferably linearly, on each other, since otherwise there is no coupling between the movements of the foci 17 and 25.

As emerges from the structure of the lithograph 2 according to FIG. 1, the drive means, that is to say the scanning mirrors 12 and 14, do not drive just the write beam 10 but also the scanning beam 22. This is because the beam splitter 20 is arranged behind the scanning mirrors 12 and 14 in the beam path of the write beam 10. Thus, the scanning beam 22 is moved two-dimensionally in the same way as the write beam 10, so that the write beam 22 is moved relative to the surface of the trigger matrix 18. This results in the movement of the scanning beam 22 being coupled with the movement of the write beam 10.

Furthermore, control means 26 are connected via a line 28 to the trigger matrix 18, in order to transmit a trigger signal to the light source 8 via a line 30 in order to control the intensity of the write beam 10. The control means 26 can in this case be formed as a fast storage chip or as a computer. By means of the signal transmitted via the line 30, the write beam 10 is modulated as a function of the position of the focus 25 of the scanning beam 22 on the trigger matrix 18, which is coupled to the position of the focus 17 of the write beam 10 on the storage medium 4.

In other words, the write beam 10 is set to write hologram points with two or more different intensity values. In the case of binary writing, the intensity is switched to and for between two different values, depending whether a point is to be written or not. Likewise, writing hologram points with a gray value graduation is possible and practical. In order to register the focus 25 on the trigger matrix 18, however, it is necessary for the lower or lowest intensity value of the write beam 10 not to be equal to 0, since the scanning beam 22 is coupled out as part of the write beam 10.

Furthermore, in the case of the structure of the lithograph 2 illustrated in FIG. 1, a length-related transmission ratio between the movement of the write beam 10 on the storage medium 4 and the scanning beam 22 on the trigger matrix 18 is predefined. This is implemented by means of different focal lengths of the two objectives 14 and 26. If, for example, the focal length of the first objective 16 is smaller by a factor 10 than the focal length of the second objective 24, then the movement of the focus 25 of the scanning beam 22 on the trigger matrix 18 is greater by the same factor 10 times than the movement of the focus 17 on the surface of the storage medium 4. In FIG. 1, only a focal length ratio of about 2 is illustrated, for reasons of space. However, this illustrates that a specific ratio is unimportant in the present configuration of the invention.

Apart from the lithograph described previously by way of example, other types of lithographs can also be used which permit accurate control of the write beam within a predefined pattern. In this case, in particular the use of the trigger matrix is not absolutely necessary, since there are also other configurations in which the beam guidance is carried out. These can be, for example, a beam guide mask connected with a timed trigger signal.

In general terms, in the present invention two deviations from the standard trigger matrix, that is to say, for example, an orthogonal pattern of the points of the digital hologram, can be distinguished.

The first type of deviation from the standard matrix relates to extensive deviations from the grid arrangement. If, for example in one of the two spatial directions, the always exactly equal spacing of the grid points is replaced by a systematically varying spacing, this may be detected macroscopically in the diffraction image.

A first example of this is illustrated in FIG. 2, in which the points of each vertical line vary sinusoidally, with a period of several grid points, from their normal position in the horizontal direction. Thus, in the reconstruction, shadows of the actual image, that is to say what are known as ghost images, can be detected, which appear to be offset horizontally in the image produced by the hologram. This is illustrated in FIG. 3.

A further type of deviation from the standard matrix is illustrated in FIG. 4. Here, within the point matrix, lines running regularly in two different directions have been inserted and, in the reproduced image illustrated in FIG. 5, lead to a corresponding geometric shape. By using this reproduced pattern, the authenticity of the hologram can be checked.

The points of the lines are additionally inserted into the hologram either deviating from the predefined pattern or brought about by intensity changes. In the exemplary embodiment illustrated in FIG. 3, the points of the lines are illustrated black at full intensity.

In a further exemplary embodiment of the first type of deviations from the standard matrix, the orthogonal pattern is replaced by a hexagonal pattern. As a result, characteristic diffraction structures in six directions are produced.

However, the deviations from the standard matrix can also be carried out in a way other than that illustrated in FIGS. 2 and 4. For example, periodic deviations from the normal position can be produced both in the vertical and in the horizontal direction. Likewise, the points can be deflected sinusoidally upward and downward relative to the normal position along a horizontal line or row. This type of variation can also be carried out in both directions. The type of geometric patterns which are added to the point matrix of the hologram can also be chosen as desired. In general, therefore, it is true that the deviations from the standard matrix are possible in various types, provided they are carried out systematically, in order to give rise to an identifier which occurs in the reproduced hologram.

For evaluation, the characteristic deviations can be interrogated by specific detectors in the readers, so that the authenticity of the holograms can therefore additionally be checked. Since these structures can be observed macroscopically when being read, there is of course the risk that these will be discovered more easily and can also been forged following appropriate analysis.

This is considerably more difficult to achieve in the solution of the second type of deviations from the standard matrix. This is because here, only individual grid points are varied without a higher-order relationship. Although this also manifests itself at a higher order in a slight elevation of the noise level in the reproduced hologram, it cannot specifically be traced back from the reproduced hologram.

The variation of individual grid points can be achieved either by means of a displacement or by means of an omission and/or insertion of individual points. Of course, care must be taken that the number of changed points does not increase excessively, otherwise the reconstruction of the hologram is impaired too greatly. The omission and/or insertion of individual points has a decisive advantage, since a typical binary hologram also appears like a randomly occupied grid, and, for the forger, the intended and the holographic omission of individual points cannot be distinguished.

The inspection of the holograms in the case of the second type of deviation from the standard matrix must proceed microscopically. In this case, both the data relating to the trigger matrix and the data relating to the hologram written in are needed in order finally to be able to establish whether the hologram has been written on a different, that is to say possibly fraudulent, machine. If only the data relating to the trigger matrix is known then, although it is not possible to make a statement with unambiguous certainty, the microscopically observed image can be correlated with the trigger matrix. Here, the result in the case of the correct matrix should be at least a quite high correlation peak. In this case, the correlation is calculated, for example, by means of three-dimensional convolution.

1. A method of producing an individualized digital computer-generated hologram,
in which the hologram is written in a storage medium as a matrix of individual points,
in which a geometric pattern for writing the holographic information in is predefined and
in which an individualizing feature is superimposed on the hologram by writing in a large number of individual points deviating from the predefined pattern.

2. The method as claimed in claim 1, in which the points deviating from the pattern are written in deviating systematically from their normal positions predefined by the pattern.

3. The method as claimed claim 2, in which the systematic deviations from a normal position are produced in at least one direction.

4. The method as claimed in claim 3, in which the systematic deviations from the normal position are produced periodically.

5. The method as claimed in claim 4, in which the period of the deviations is chosen to be greater than the grid spacing of the pattern.

6. The method as claimed in claim 2, in which, in addition to the points to be written in in the predefined pattern, points in the form of a geometric pattern are written in at locations deviating from the pattern.

7. The method as claimed in claim 2, in which an orthogonal pattern is chosen as the pattern, and in which the individual points of the hologram are at least partly written in in a hexagonal pattern.

8. The method as claimed in claim 1, in which the points deviating from the pattern are written in deviating non-systematically from the pattern.

9. The method as claimed in claim 8, in which the deviations are produced by omitting and/or inserting individual points.

10. The method as claimed in claim 8, characterized in that the deviations are produced by displacing individual points from their normal positions predefined by the pattern.

11. A method of reading an individualized digital computer-generated hologram,
in which the hologram written in a storage medium is illuminated with a beam of electromagnetic radiation, the hologram having basic information and at least one individualizing feature,
in which the image produced by the hologram is recorded by recording means and evaluated with the aid of image recognition, and
in which the at least one individualizing feature contained in the hologram is checked.

12. A storage medium having a digital computer-generated hologram,
having individual points which are written in the material of the storage medium, are arranged in a predefined geometric pattern and form the hologram,
having a large number of individual points which are written in the material of the storage medium deviating from the predefined pattern.
